(19) United States
(12) Patent Application Publication
(10) Pub. No.: US 2006/0075138 A1
(43) Pub. Date: Apr. 6, 2006

(54) Method and apparatus to facilitate IPv6 DNS requests

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/952,319

(22) Filed: Sep. 28, 2004

(51) Int. Cl. G06F 15/16

(52) U.S. Cl. 709/245

(57) ABSTRACT

A network element, such as a Packet Data Serving Node, serves both as a traditional Packet Data Serving Node and as a Domain Name Server proxy. So configured, Internet Protocol version 6 mobile nodes can successfully source Domain Name Server requests and receive Domain Name Server replys from Internet Protocol version 4 Domain Name Servers. Pursuant to a preferred approach, Domain Name System identifiers as used by the mobile node are mapped to one or more items of information, such as a Point-to-Point Protocol context, a modified Domain Name System identifier, addressing, and the like.

### TECHNICAL FIELD

This invention relates generally to Internet Protocol (IP) version 6 (IPv6) and more particularly to Domain Name Server (DNS) requests.

### BACKGROUND

Domain Name Servers are known in the art. Such network elements typically map names to Internet Protocol addresses and vice versa. For example, Domain Name Servers maintain central lists of domain name/Internet Protocol address and utilize such lists to map the domain names contained in submitted Internet requests to other servers on the Internet until, for example, a specified web site is located. Internet Protocol version 4 addresses for such Domain Name Servers are typically provided to a mobile node via Internet Protocol Control Protocol (IPCP, which typically specifies the control protocol used to support the Internet Protocol on Point-to-Point Protocol links) attributes.

Internet Protocol version 6 has been defined to be supported on a Packet Data Serving Node (PDSN). Notwithstanding several proposals, however, no standard method presently exists to provide a mobile node with the Internet Protocol version 6 address (or addresses) of one or more Domain Name Servers. Though the Internet Protocol version 4 approach described above has been proposed, it appears unlikely to be accepted as a standard methodology.

Another proposed but unlikely approach would add Domain Name Server Internet Protocol version 6 addresses to Internet Control Message Protocol version 6 router advertisements. This approach is unlikely because Dynamic Host Configuration Protocol (DHCP) version 6 appears to be the overall solution of choice. Unfortunately, not all mobile nodes are presently, or likely, to be compatible with DHCP v6. For example, CDMA2000 mobile nodes do not presently support DHCP v6 nor is this likely as DHCP v6 is otherwise unnecessary in CDMA2000.

### BRIEF DESCRIPTION OF THE DRAWINGS

The above needs are at least partially met through provision of the method and apparatus to facilitate IPv6 DNS requests described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a timing diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, a Packet Data Serving Node serves both as an ordinary Packet Data Serving Node and, on occasion, as a Domain Name Server proxy. So configured, upon receiving an Internet Protocol version 6 communication other than a Domain Name Server request from an Internet Protocol version 6 mobile node, the Packet Data Serving Node forwards a corresponding Internet Protocol version 6 message on behalf of the Internet Protocol version 6 mobile node in ordinary course. Upon receiving a Domain Name Server request from an Internet Protocol version 6 mobile node, however, the Packet Data Serving Node interacts with the Internet Protocol version 6 mobile node as a proxy for at least one Domain Name Server.

Pursuant to some approaches, this can comprise receiving Domain Name Server requests that use link local. Those skilled in the art will recognize, however, that various other approaches can be utilized, including but not limited to global version 6 addressing, and these teachings are not limited to link local usage alone. Internet Protocol version 6 addressing to present a Domain Name System identifier and modifying that Domain Name System identifier to provide a modified Domain Name System identifier. This, in turn, can preferably comprise mapping the modified Domain Name System identifier to at least one (and possibly all) of a Domain Name System identifier, an Internet Protocol version 4 address as corresponds to a selected Domain Name Server, and a Point-to-Point Protocol context. Pursuant to some approaches, such a map may only be maintained for no more than a predetermined period of time (such as, for example, a user-selectable predetermined period of time).

So configured, an Internet Protocol version 6 mobile node, such as a CDMA2000 mobile node, can readily achieve the desired Domain Name Server interaction without requiring modifications to the mobile node and in a manner that is readily supported by existing infrastructure with only minimal modification.

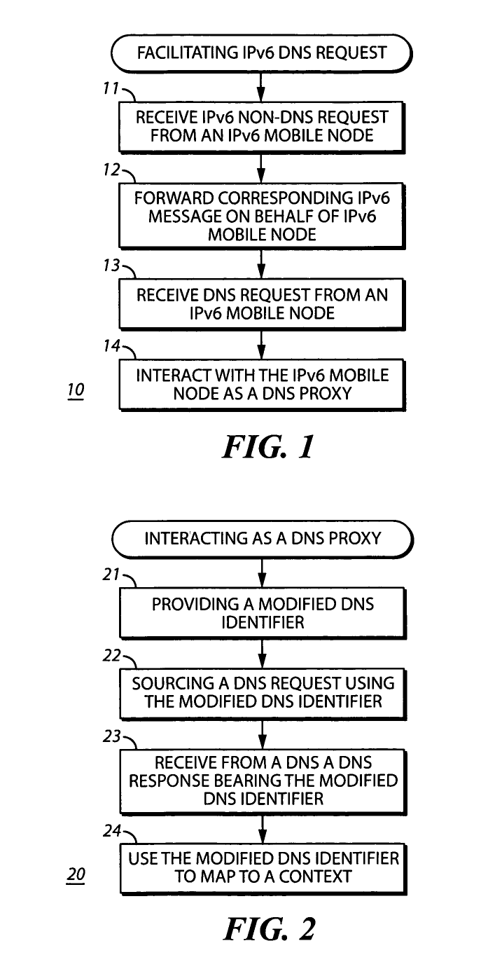

These and other benefits may become more evident upon making a thorough review and study of the following detailed description. Referring now to the drawings, and in particular to FIG. 1, a general process 10 to facilitate Internet Protocol version 6 Domain Name Server requests via, for example, a Packet Data Serving Node can accommodate the reception 11 of Internet Protocol version 6 communications other than a Domain Name Server request as transmitted by a given Internet Protocol version 6 mobile node by forwarding 12 a corresponding Internet Protocol version 6 message on behalf of the Internet Protocol version 6 mobile node. Such reception and forwarding can accord with present practice in this regard if desired. As such functionality is well understood in the art, further elaboration and details are not presented here for the sake of brevity and the preservation of focus.

This same process 10, upon receiving 13 a Domain Name Server request from such an Internet Protocol version 6 mobile node, will facilitate interaction 14 with that Internet Protocol version 6 mobile node as a proxy for a Domain Name Server. More particularly, when the enabling platform comprises a Packet Data Serving Node, this process 10 enables the Packet Data Serving Node to behave as a Domain Name Server proxy in contrast to ordinary prior art practice. This reception 13 of a Domain Name Server request can comprise, for example, a Domain Name Server request that uses link local Internet Protocol version 6 addressing. In a preferred approach this request comprises, at least in part, a Domain Name System identifier.

The above referenced interaction 14 can comprise, for example, modifying a Domain Name System identifier as was received 13 from the mobile node to provide a modified Domain Name System identifier. This interaction can further comprise mapping the modified Domain Name System identifier to one or more (and preferably all) of the original Domain Name System identifier, an Internet Protocol version 4 address as corresponds to a selected Domain Name Server, and/or a Point-to-Point context as characterizes and identifies the present link between the Packet Data Serving Node and the mobile node.

Depending upon the needs and/or requirements of a given application, it may not be desirable to retain such mapping information in perpetuity. In such a case, this interaction 14 can further comprise only maintaining the resultant map (or some portion thereof) for no more than a predetermined period of time (such as a few seconds, minutes, hours, days, and the like). If desired, the predetermined period of time can comprise a user-selectable predetermined period of time (for example, to permit a system administrator to modify this value to better comport with local needs or sensitivities). It would also be possible to provide a dynamic mechanism to vary the period of time as a function of one or more monitored events, conditions, settings, or the like. For example, a shorter period of time may be used during times of the day when system usage places greater needs upon the memory resources of the system infrastructure.

Those skilled in the art will understand that a Domain Name Server response may not always be received following transmission of a Domain Name Server request as described above. This can occur for various reasons. Pursuant to one approach, upon determining that a first Domain Name Server has failed to respond to such a request, the enabling platform can then automatically select a second Domain Name Server to which a subsequent Domain Name Server request shall be sent. Such a second Domain Name Server can be selected, for example, from a list of available Domain Name Servers using, if desired, a round robin or other circular queue approach or some other selection criteria or technique of choice. In general, when such a failure to respond occurs, the enabling platform will preferably not provide information to the Internet Protocol version 6 mobile node regarding such a failure to respond. Instead, if and when the mobile node resends its original request, the enabling platform can operate as described above, using the next selectable Domain Name Server from its list.

Referring now to FIG. 2, as already noted above, enabling interaction as a Domain Name Server proxy preferably comprises modification 21 of an original Domain Name System identifier to thereby yield a modified Domain Name System identifier. This interaction as a proxy process 20 can further comprise sourcing a Domain Name Server request using the modified Domain Name System identifier to a Domain Name Server and receiving 23 from that Domain Name Server a Domain Name Server response that bears the modified Domain Name System identifier. This process 20 then facilitates using 24 the received modified Domain Name System identifier to map the Domain Name Server response to corresponding useful information. For example, this modified Domain Name System identifier (with or without a destination Internet Protocol address) can point to the previously correlated Point-to-Point Protocol context as corresponds to the original mobile node. As another example, this process can effect use of at least the modified Domain Name System identifier to map the Domain Name Server response to the original Domain Name System identifier (alone or in combination with a corresponding Point-to-Point Protocol context). This then permits the interaction to further comprise forming a Domain Name Server proxy response using the original Domain Name System identifier and sending that Domain Name Server proxy response via Internet Protocol version 6 to the original mobile node using the original Domain Name System identifier.

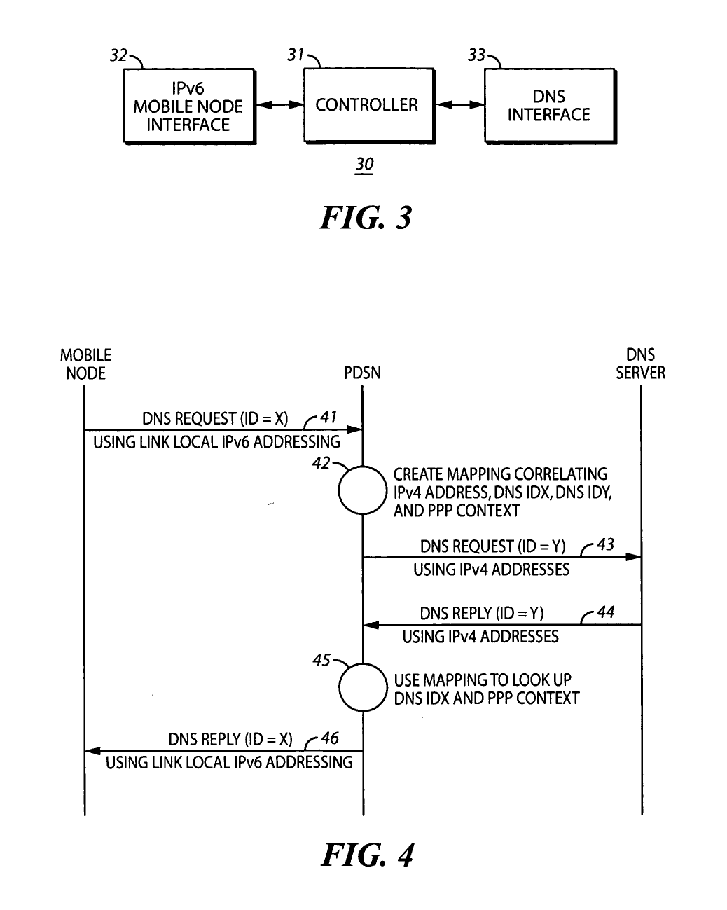

These teachings can be implemented via a variety of enabling platforms though, as already noted, these teachings have particular benefit when applied in conjunction with a Packet Data Serving Node. Regardless, and referring now to FIG. 3, an enabling platform will typically comprise a controller 31, an Internet Protocol version 6 mobile node interface 32 that operably couples to the controller 31, and a Domain Name Server interface 33 that also opreably couples to the controller 31. The controller 31 preferably comprises a wholly or at least partially programmable platform to more readily permit programming in conformance with these teachings. Pursuant to a preferred approach, the controller 31 is adapted and configured to receive Internet Protocol version 6 communications other than Domain Name Server requests from Internet Protocol version 6 mobile nodes and to forward corresponding Internet Protocol version 6 messages on behalf of the Internet Protocol version 6 mobile node. This controller 31 is also preferably adapted and configured to receive Domain Name Server requests from Internet Protocol version 6 mobile nodes and to interact with such Internet Protocol version 6 mobile nodes as a proxy for a Domain Name Server.

These actions and reactions preferably correspond to the above-described processes and in particular will preferably encompass the above-described Domain Name System identifier modification and mapping activity to thereby facilitate the above-described Domain Name Server and mobile node interaction.

An illustrative series of communications and actions as correspond to these teachings appear in FIG. 4. In this illustrative example, when a Packet Data Serving Node receives a Domain Name Server request 41 from a mobile node (which request 41 uses, for example, link local Internet Protocol version 6 addressing and which identifies a given Domain Name Server using identifier “X”), the Packet Data Serving Node creates 42 mapping that correlates, in this example, various pieces of information including a corresponding Internet Protocol version 4 address (or, of course, such other transport protocol and addressing as may be available and relevant in a given application), Domain Name Server identifier “X,” Domain Name Server identifier “Y,” and the current applicable Point-to-Point Protocol context. The Packet Data Serving Node then sources a Domain Name Server request 43 using identifier “Y” and Internet Protocol version 4 addressing (again noting that other addressing schemes may be applicable in a given context and used accordingly).

A receiving Domain Name Server provides a Domain Name Server reply 44 that also uses that same identifier “Y” and Internet Protocol version 4 addressing (or other corresponding addressing scheme as is relevant to a specific application). Upon receiving this reply 44, the Packet Data Serving Node uses 45 its previously formulated mapping to correlate Domain Name Server identifier “Y” (and, optionally, the Internet Protocol version 4 destination address) with Domain Name Server identifier “X” and the existing Point-to-Point Protocol context. The Packet Data Serving Node then uses this recovered Domain Name Server identifier “X” and Point-to-Point Protocol context to facilitate provision of a Domain Name Server reply 47 to the mobile node that uses Domain Name Server identifier “X” and link local Internet Protocol version 6 addressing.

So configured, the Packet Data Serving Node serves both as a traditional Packet Data Serving Node while also serving as a Domain Name Server proxy to facilitate the corresponding needs of its mobile node population. Those skilled in the art will appreciate that these teachings permit successful interaction between Internet Protocol version 6 mobile nodes and Internet Protocol version 4 Domain Name Servers without requiring modification of either endpoint.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method to facilitate Internet Protocol version 6 Domain Name Server requests comprising:
receiving an Internet Protocol version 6 communication other than a Domain Name Server request from an Internet Protocol version 6 mobile node and forwarding a corresponding Internet Protocol version 6 message on behalf of the Internet Protocol version 6 mobile node;
receiving a Domain Name Server request from an Internet Protocol version 6 mobile node and interacting with the Internet Protocol version 6 mobile node as a proxy for a Domain Name Server.

2. The method of claim 1 wherein receiving a Domain Name Server request from an Internet Protocol version 6 mobile node further comprises:
receiving a Domain Name Server request that uses link local Internet Protocol version 6 addressing.

3. The method of claim 2 wherein receiving a Domain Name Server request that uses link local Internet Protocol version 6 addressing further comprises:
receiving a Domain Name Server request that comprises a Domain Name System identifier.

4. The method of claim 3 wherein interacting with the Internet Protocol version 6 mobile node as a proxy for an Internet Protocol version 4 Domain Name Server further comprises:
modifying the Domain Name System identifier to provide a modified Domain Name System identifier.

5. The method of claim 4 wherein modifying the Domain Name System identifier to provide a modified Domain Name System identifier further comprises:
mapping the modified Domain Name System identifier to at least one of:
the Domain Name System identifier;
an Internet Protocol version 4 address as corresponds to a selected Domain Name Server;
a Point-to-Point Protocol context.

6. The method of claim 5 wherein mapping the modified Domain Name System identifier to at least one of the Domain Name System identifier, an Internet Protocol version 4 address as corresponds to a selected Domain Name Server, and a Point-to-Point Protocol context further comprises:
mapping the modified Domain Name System identifier to each of:
the Domain Name System identifier;
an Internet Protocol version 4 address as corresponds to a selected Domain Name Server;
a Point-to-Point Protocol context.

7. The method of claim 6 wherein mapping the modified Domain Name System identifier further comprises only maintaining a resultant map for no more than a predetermined period of time.

8. The method of claim 7 wherein only maintaining a resultant map for no more than a predetermined period of time further comprises only maintaining a resultant map for no more than a user-selectable predetermined period of time.

9. The method of claim 6 wherein interacting with the Internet Protocol version 6 mobile node as a proxy for a Domain Name Server further comprises:
sourcing a Domain Name Server request using the modified Domain Name System identifier to a Domain Name Server.

10. The method of claim 9 wherein sourcing a Domain Name Server request using the modified Domain Name System identifier to a Domain Name Server further comprises not re-sourcing the Domain Name Server request regardless of any lack of a response to the Domain Name Server request.

11. The method of claim 9 wherein interacting with the Internet Protocol version 6 mobile node as a proxy for a Domain Name Server further comprises:
receiving from the Domain Name Server a Domain Name Server response that bears the modified Domain Name System identifier.

12. The method of claim 11 wherein interacting with the Internet Protocol version 6 mobile node as a proxy for a Domain Name Server further comprises:
using at least the modified Domain Name System identifier to map the Domain Name Server response to the Point-to-Point Protocol context.

13. The method of claim 12 wherein using at least the modified Domain Name System identifier to map the Domain Name Server response to the Point-to-Point Protocol context further comprises:
using at least the modified Domain Name System identifier and a destination Internet Protocol address to map the Domain Name Server response to the Point-to-Point Protocol context.

14. The method of claim 11 wherein interacting with the Internet Protocol version 6 mobile node as a proxy for a Domain Name Server further comprises:
using at least the modified Domain Name System identifier to map the Domain Name Server response to the Domain Name System identifier.

15. The method of claim 14 wherein using at least the modified Domain Name System identifier to map the Domain Name Server response to the Domain Name System identifier further comprises:
using at least the modified Domain Name System identifier to map the Domain Name Server response to the Domain Name System identifier and the Point-to-Point Protocol context.

16. The method of claim 15 wherein interacting with the Internet Protocol version 6 mobile node as a proxy for a Domain Name Server further comprises:
forming a Domain Name Server proxy response using the Domain Name System identifier.

17. The method of claim 16 wherein interacting with the Internet Protocol version 6 mobile node as a proxy for a Domain Name Server further comprises further comprises:
sending the Domain Name Server proxy response via Internet Protocol version 6 using the Domain Name System identifier to the mobile node.

18. The method of claim 17 wherein the method to facilitate Internet Protocol version 6 Domain Name Server requests comprises a method for use by a packet data serving node.

19. The method of claim 1 wherein receiving a Domain Name Server request from an Internet Protocol version 6 mobile node and interacting with the Internet Protocol version 6 mobile node as a proxy for a Domain Name Server further comprises:
determining when a first Domain Name Server has failed to respond and selecting a second Domain Name Server to which a subsequent Domain Name Server request shall be sent.

20. The method of claim 19 and further comprising:
not providing information to the Internet Protocol version 6 mobile node regarding such a failure to respond.

21. The method of claim 19 wherein selecting a second Domain Name Server further comprises sequentially selecting the second Domain Name Server from a list of available Domain Name Servers.

22. The method of claim 21 wherein sequentially selecting the second Domain Name Server from a list of available Domain Name Servers further comprise sequentially selecting the second Domain name Server from a list of available Domain Name Servers, wherein the list comprises a circular queue.

23. An apparatus comprising:
an Internet Protocol version 6 mobile node interface;
a Domain Name Server interface;
a controller operably coupled to the Internet Protocol version 6 mobile node interface and to the Domain Name Server interface and being adapted and configured to:
receive an Internet Protocol version 6 communication other than a Domain Name Server request from an Internet Protocol version 6 mobile node and forward a corresponding Internet Protocol version 6 message on behalf of the Internet Protocol version 6 mobile node;
receive a Domain Name Server request from an Internet Protocol version 6 mobile node and interact with the Internet Protocol version 6 mobile node as a proxy for a Domain Name Server.

24. The apparatus of claim 23 wherein the controller further comprises means for receiving a Domain Name Server request from an Internet Protocol version 6 mobile node that uses link local Internet Protocol version 6 addressing and that comprises a Domain Name System identifier.

25. The apparatus of claim 24 wherein the controller further comprises means for modifying the Domain Name System identifier to provide a modified Domain Name System identifier.

26. The apparatus of claim 25 wherein the controller further comprises means for mapping the modified Domain Name Server to each of:
the Domain Name System identifier;
an Internet Protocol address as corresponds to a selected Domain Name Server;
a Point-to-Point Protocol context as corresponds to the mobile node.

27. The apparatus of claim 26 wherein the controller further comprises means for sourcing a Domain Name Server request using the modified Domain Name System identifier to a Domain Name Server and receiving from the Domain Name Server a Domain Name Server response that bears the modified Domain Name System identifier.

28. The apparatus of claim 27 wherein the controller further comprises means for using at least the modified Domain Name System identifier as comprises a part of the Domain Name Server response to map the Domain Name Server response to the Domain Name System identifier and the Point-to-Point Protocol context to provide a recovered Domain Name System identifier.

29. The apparatus of claim 28 wherein the controller further comprises means for forming a Domain Name Server proxy response using the recovered Domain Name System identifier.

30. The apparatus of claim 28 wherein the apparatus comprises a packet data serving node.
